(19) United States
(12) Patent Application Publication
(10) Pub. No.: US 2018/0031065 A1
(43) Pub. Date: Feb. 1, 2018

(54) ELECTROMECHANICAL BRAKE SYSTEM AND METHOD

(71) Applicant: GM GLOBAL TECHNOLOGY OPERATIONS LLC, Detroit, MI (US)

(72) Inventors: Ali Shabbir, Oshawa (CA); David Begleiter, Oshawa (CA)

(21) Appl. No.: 15/220,829

(22) Filed: Jul. 27, 2016

(51) Int. Cl. F16D 66/02

(52) U.S. Cl. CPC F16D 66/021; F16D 55/225

(57) ABSTRACT

An electromechanical brake system capable of conducting a brake pad wear check includes a structure defining a chamber, a member that rotates with a wheel, a motor mounted to the structure, a reciprocating piston, a brake pad, and a controller. The piston is driven by the motor between a variable actuated position and a retracted position. The brake pad is movably supported by the structure, operatively coupled to the piston, and adapted for braking contact with the member when the piston is in the actuated position, and spaced from the member when the piston is in the retracted position. The controller controls reciprocation of the piston between the actuated and retracted positions via energization of the motor, performs a brake pad wear check by calculating a change in a parameter associated with a change in distance between positions, and compares the change in parameter to a threshold value.

### FIELD OF THE INVENTION

The subject invention relates to an electromechanical brake system, and more particularly, to a method of determining brake pad lining wear as part of the electromechanical brake system.

### BACKGROUND

Traditional service braking systems of a vehicle are typically hydraulic fluid based systems actuated by a driver depressing a brake pedal that generally actuates a master cylinder. In-turn, the master cylinder pressurizes hydraulic fluid in a series of hydraulic fluid lines routed to respective actuators at brakes located adjacent to each wheel of the vehicle. Such hydraulic braking may be supplemented by a hydraulic modulator assembly that facilitates anti-lock braking, traction control, and vehicle stability augmentation features. The wheel brakes may be primarily operated by the manually actuated master cylinder with supplemental actuation pressure gradients supplied by the hydraulic modulator assembly during anti-lock, traction control, and stability enhancement modes of operation. Hydraulic brake systems are known to include dedicated brake wear sensors (e.g., clip-on sensors) generally placed upon or secured to the brake pad itself for detecting brake wear. Unfortunately, such clip-on sensors may not be robust, are costly, and may require replacement with worn brake pads.

More recent brake designs may include brake assemblies with an electromechanical park brake feature as part of the actuator. With such a feature, the driver merely presses a button to electrically actuate the brakes into a park brake mode. Yet further, recent brake system designs may not include any hydraulics. Such systems may be known as brake-by-wire (BBW) systems that electrically actuate the brakes during both service and park brake modes of operation. Such systems with electro-mechanical attributes may still include the clip-on sensors applicable for hydraulic systems to determine brake pad wear.

Accordingly, it is desirable to provide a brake pad wear check process and related hardware that may better utilize attributes of electromechanical brake components to reduce system costs, simplify complexity, and improve robustness.

### SUMMARY OF THE INVENTION

In one exemplary embodiment of the present disclosure, an electromechanical brake system includes a structure defining a chamber, a member adapted to rotate with a vehicle wheel, an electric motor mounted to the structure, a piston, a brake pad, and a controller. The piston is coupled to the electric motor for reciprocation within the chamber between a variable actuated position and a retracted position. The brake pad is movably supported by the structure, operatively coupled to the piston, and adapted to be in braking contact with the member when the piston is in the actuated position, and spaced from the member when the piston is in the retracted position. The controller is configured to control reciprocation of the piston between the actuated and retracted positions via energization of the motor, perform a brake pad wear check by calculating a change in a parameter associated with a change in distance between the retracted position and the variable actuated position, and comparing the change in parameter to a preprogrammed threshold value.

In another exemplary embodiment, a method of performing a brake pad wear check includes the step of driving a piston from a retracted position to a clamped position via an electric motor. A current spike induced by the electric motor when the piston is in the clamped position is then sensed by a controller. A parameter associated with the movement from the retracted position and to the clamped position is then measured. The parameter is then compared to a predetermined threshold to determine brake pad wear.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic plan view of a vehicle having an electromechanical brake system as one, non-limiting, example in accordance with the present disclosure;

FIG. 2 is a side view of a brake assembly of the electromechanical brake system with sections removed to show internal detail; and

FIG. 3 is a flow chart of a method of performing a brake pad wear check.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the terms module and controller refer to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

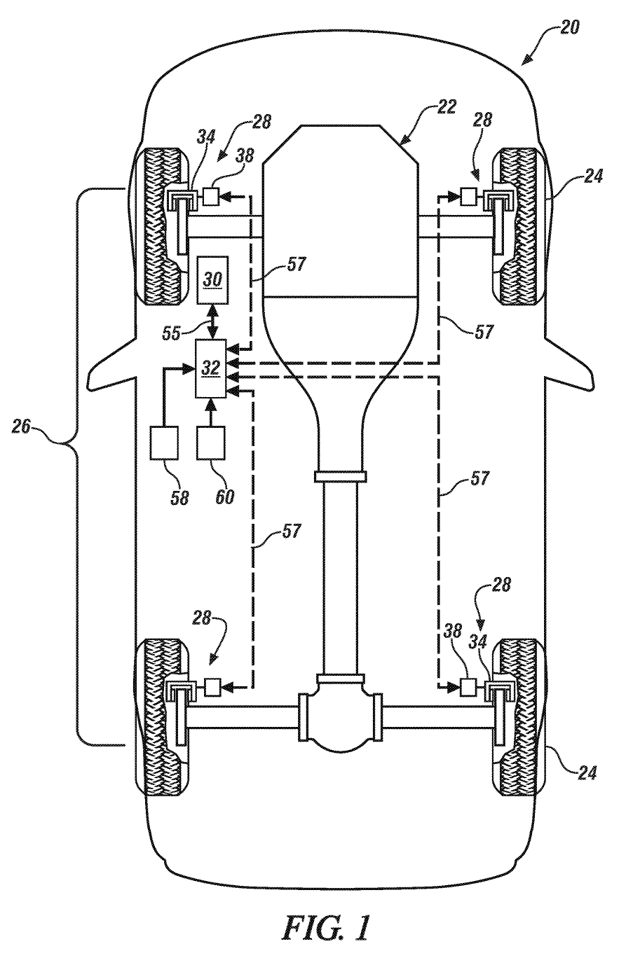

In accordance with an exemplary embodiment of the invention, FIG. 1 is a schematic of a vehicle 20 that may include a powertrain 22 (i.e., an engine, transmission and differential), a plurality of rotating wheels 24 (i.e., four illustrated), and an electromechanical brake system 26 that may include a brake assembly 28 for each respective wheel 24, a brake pedal assembly 30, and a controller 32. The powertrain 22 is adapted to drive at least one of the wheels 24 thereby propelling the vehicle 20 upon a surface (e.g., road). The electromechanical brake system 26 is configured to generally slow the speed and/or stop motion of the vehicle 20. The vehicle 20 may be an automobile, truck, van, sport utility vehicle, or any other self-propelled or towed conveyance suitable for transporting a burden. The electromechanical brake system 26 may be a brake-by-wire (BBW) system, or may be any variety of more traditional hydraulic braking systems having an electromechanical brake assembly 28. In one example, the brake assembly 28 may be constructed and arranged to operate hydraulically during normal braking of the vehicle 20, and operate electromechanically when actuating a parking brake.

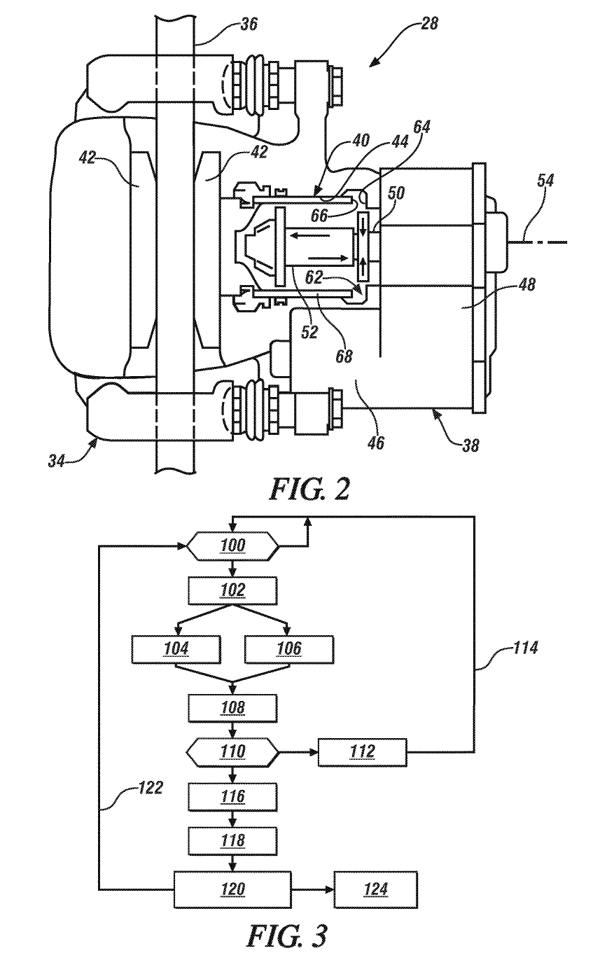

Referring to FIG. 2, each brake assembly 28 of the electromechanical brake system 26 may include a structure 34, a member 36, a drive unit 38, a piston 40, and at least one brake pad 42. The structure 34 may be, or may include, a caliper, and may define the boundaries of a piston chamber 44. The member 36 is constructed and arranged to generally rotate with the wheel 24, and may be a brake disc or rotor. The piston 40 is disposed for reciprocation in the piston chamber 44, and is generally driven by the drive unit 38. The brake pad 42 may be two brake pads located on opposite sides of the brake disc 36 and generally supported by the caliper 34 for movement toward and away from the respective sides of the brake disc 36.

The drive unit 38 may include an electric motor 46, a geared drive 48, a screw 50, and a nut 52. In operation, the electric motor 46 generally powers or drives the geared drive 48 which rotates the screw 50 that may extend along an axis 54 extending in the direction of piston and brake pad travel. Because the nut 52 is threaded to the screw 50, the nut 52 bears upon the piston 40, which may contact the brake pad 42 and press the brake pad against the brake disc 36 as the screw 50 rotates. Reverse rotation of the screw 50 causes the brake pad to release from the brake disc 36 and moves the piston 40 away from the brake disc 36. It is contemplated and understood that the nut 52 may be an integral part (e.g., one unitary part) of the piston 40 or may be two separate components. It is further contemplated and understood that the drive unit 38 may be part of a BBW system, or may be dedicated toward a park brake feature.

In other, non-limiting, embodiments, the brake assembly 28 may be a drum brake assembly, or other types. The drive unit 38 may be an electro-hydraulic brake actuator (EHBA) or other actuator capable of moving the brake pad 42 against the rotating member 36 in response to an electrical command signal from the controller 32. More specifically, the drive unit 38 may be, or may include, any type of motor capable of acting upon a received electric signal and, as a consequence, converting energy into motion that controls movement of the piston 40. Thus, the motor 46 may be a direct current motor configured to generate electro-hydraulic pressure delivered to, for example, the piston 40.

Referring to FIG. 1, and with respect to the embodiment of a BBW system 26, the controller 32 may include a computer-based processor (e.g., microprocessor) and a computer readable and writeable storage medium. In operation, the controller 32 may receive one or more electrical signals from the brake pedal assembly 30 over a pathway (see arrow 55) indicative of driver braking intent. In-turn, the controller 32 may process such signals, and based at least in-part on those signals, output an electrical command signal to the drive unit 38 over a pathway (see arrow 57). Based on any variety of vehicle conditions, the command signals directed to each wheel 24 may be the same or may be distinct signals for each wheel 24. The pathways 55, 57 may be wired pathways, wireless pathways, or a combination of both. Non-limiting examples of the controller 32 may include an arithmetic logic unit that performs arithmetic and logical operations; an electronic control unit that extracts, decodes, and executes instructions from a memory; and, an array unit that utilizes multiple parallel computing elements.

Other examples of the controller 32 may include an engine control module, and an application specific integrated circuit. It is further contemplated and understood that the controller 32 may include redundant controllers, and/or the system may include other redundancies, to improve reliability of the BBW system 26.

In another embodiment, where the brake system 26 may not be a BBW system, and instead may include more traditional hydraulic components for normal service or operation of the brake system 26, the brake assembly 28 may include an electromechanical park brake feature. That is, the system 26 may use hydraulic components for decelerating a vehicle down via driver actuation of the brake pedal assembly 30, but when initializing a parking brake feature, the brake assembly 28 operates electromechanically utilizing the drive unit 38 (see FIG. 2).

The brake system 26 and/or brake assembly 28 may include a subsystem and/or the ability to determine brake pad lining wear. To facilitate this ability, the brake system 26 may further include a vehicle level sensor 58 (e.g., multi-axis accelerometer) and an ignition position module 60 that may be hardware and/or software based. The vehicle level sensor 58 and the ignition position module 60 are configured to both input data (e.g., signal) to the controller 32 used as part of a process to determine brake pad wear.

In order to check for brake pad wear, the controller 32 may be configured to measure or detect an increase in piston 40 travel along axis 54, and between a clamped or actuated position and a retracted position. The actuated position generally signifies firm contact of the brake pad 42 to the brake disc 36, and varies in placement depending upon the degree of wear of the brake pad 42. The retracted position is generally a reference point positioned along the axis 54, and generally denoting a pre-established and constant distance of, for example, the piston 40 from the brake disc 36. When the piston 40 is in the retracted position, the brake pad 42 is not in contact with the brake disc 36 (i.e., is spaced from the brake disc).

The controller 32 may determine when the piston 40 along with the brake pad 42 is in the actuated position by receiving a signal indicative of a first energy peak, or current spike, that results when the electric motor 46 strains to further move the brake pad 42 against the brake disc 36. The retracted position is similarly determined except that the energy peak may be established once during a setup or initialization process by the system 26 to determine the reference point location along axis 54. More specifically, a stop 62 may be carried between a surface 64 carried by the caliper 34 and defining in-part a boundary of the piston chamber 44, and a face 66 that may be carried by a trailing skirt 68 of the piston 40. In one example, the surface 64 of the caliper 34, and the face 66 of the trailing skirt 68 may be generally annular in shape and opposed to one-another.

During an initialization process, the controller 32 may energize the motor 46 causing the piston 40 to axially move toward the surface 64 of the caliper 34. This movement continues until the surface 64 of the piston 40 contacts the face 66 (i.e., stop 62 is engaged). Immediately after contact, the continued exertion of the motor 46 causes a second energy peak (e.g., current spike) that is received by the controller 32. The actual reference point utilized during prescheduled brake pad wear checks, and determined by the controller 32, may be at some distance before the stop 62 engages. It is further contemplated and understood that the reference point may be alternatively established utilizing a motor position sensor with a designed ‘home’ retraction position. One example of a motor position sensor may be an encoder.

In one embodiment, an internal clock of the controller 32 measures a time duration between first and second energy peak occurrences. Because the rate of axial travel of the piston 40 may be known, an axial distance of piston travel between actuated and retracted positions, associated with the reference point, may be calculated by the controller 32. The piston travel distance between states will increase as the brake pad wears. The controller 32 may be configured to monitor the change in distance until a pre-programmed threshold is reached. When the threshold is reached, the controller 32 may be programmed to react. As one example, the controller 32 may notify the vehicle driver in the form of a visual indicator. It is further contemplated and understood that the distance measured may not be a function of time. Instead, the controller 32 may recognize a change in motor position from the reference point indicated by a motor encoder. It is contemplated and understand that the controller 32 may generally monitor any parameter (e.g., travel distance and/or time) associated with piston travel between the actuated and retracted positions, and compare this parameter to a predetermined threshold value thus establishing, for example, a remaining life estimate of the brake pad.

Referring to FIG. 3, the controller 32 may be programmed to perform periodic brake pad wear checks contingent upon certain vehicle conditions being met. That is, in one embodiment, a diagnostic test to collect pad wear information may be run in accordance with the flow chart of FIG. 3. In block 100 of a method of performing brake pad wear checks, the controller 32 may determine if a pre-programmed check interval has lapsed. If yes, and in block 102, the controller may confirm the vehicle 20 is in park (e.g., via a transmission position), the ignition or key is off via the ignition position module 60, and the vehicle 20 is parked on substantially level ground via the level sensor 58. If yes to all three self-verifications and in block 104, the controller 32 may initiate a brake pad wear check by self-energizing the park brake feature via the motor 46. Also, and if yes to all three self-verifications, and in block 106, if a driver electrically activates the park brake feature, the controller 32 may initiate the park brake check.

In block 108, the initialization process is generally conducted by retracting the piston 40. In block 110, after the controller 32 initiates a brake pad wear check, the controller 32 may confirm that a reference point was pre-established. If “no” to a reference point being pre-established, and in block 112, a brake system diagnosis may be in order, and/or the initialization process may be performed as previously described (see arrow 114). If “yes” to a reference point being pre-established, and in block 116, the controller actuates the piston 40 via the drive unit 38, and moves the piston from the retracted position and into the actuated or clamped state. In block 118, the resulting travel data is stored within, for example, the memory of the controller 32. In block 120, the controller 32 may calculate and update remaining brake lining thickness within an algorithm while re-initializing the clock for the next check (see arrow 122). In block 124, information relative to the remaining brake pad life may be communicated to the driver.

Advantages and benefits of the present disclosure include the ability to provide a driver with actual continuous measurement of remaining brake pad life without the use of dedicated, consumable, sensors, thus avoiding the expense of electrical sensor(s) and wiring harnesses. Another advantage is the avoidance of brake pad geometry changes and caliper design and tooling changes that may be driven by known clip-in electrical sensor and wire routing. Yet further, a brake system is provided that may include lower costs, improved accuracy in determining brake pad wear, and reduced complexity.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An electromechanical brake system configured to control the rotational speed of a wheel, the electro-mechanical brake system comprising:
a structure defining a piston chamber;
a member constructed and arranged to rotate with the wheel;
an electric motor mounted to the structure;
a piston coupled to the electric motor for reciprocation within the piston chamber between a retracted position and a variable actuated position;
a brake pad movably supported by the structure, operatively coupled to the piston, and constructed and arranged to be in braking contact with the member when the piston is in the actuated position, and spaced from the member when the piston is in the retracted position, and wherein the variable actuated position is dependent upon wear of the brake pad;
a controller configured to control reciprocation of the piston between the retracted position and the variable actuated position via energization of the electric motor, and to determine the variable actuated position via a first energy peak induced by the electric motor; and
wherein the controller is configured to perform a brake pad wear check by calculating a change in a parameter associated with a change in distance between the retracted position and the variable actuated position, and comparing the change in parameter to a preprogrammed threshold value.

2. The electromechanical brake system set forth in claim 1, wherein the retracted position is based on a reference point preprogrammed into the controller.

3. The electromechanical brake system set forth in claim 2, wherein the parameter is a time duration, and the controller is configured to measure the time duration needed to move the piston between the actuated and retracted positions, and determine if the time duration exceeds the pre-programmed threshold value.

4. The electromechanical brake system set forth in claim 3, wherein the time duration is a function of rate of travel of the piston.

5. The electromechanical brake system set forth in claim 4 further comprising:
a stop carried between the piston and the structure for initializing the retracted position, and wherein the controller is configured to engage the stop via energization of the electric motor producing a second energy peak indicative of the retracted position.

6. The electromechanical brake system set forth in claim 2, wherein the reference point is associated with a position of the electric motor.

7. The electro-mechanical brake system set forth in claim 2, wherein the structure includes a caliper and the member is a brake disc.

8. The electro-mechanical brake system set forth in claim 2, wherein the electro-mechanical brake system is a park brake system.

9. The electro-mechanical brake system set forth in claim 2, wherein the electro-mechanical brake system is a brake-by-wire (BBW) system.

10. The electro-mechanical brake system set forth in claim 2 further comprising:
a vehicle level sensor configured to input a signal to the controller to determine that the vehicle is level prior to performing the brake pad wear check.

11. A method of performing a brake pad wear check comprising:
driving a piston from a retracted position to a clamped position via an electric motor;
sensing a current spike by a controller and induced by the electric motor when the piston is in the clamped position;
measuring a parameter associated with the movement from the retracted position to the clamped position; and
comparing this parameter to a predetermined threshold to determine brake pad wear.

12. The method set forth in claim 11 further comprising:
confirming that a vehicle is in park prior to driving the piston.

13. The method set forth in claim 11 further comprising:
confirming that a vehicle is level prior to driving the piston.

14. The method set forth in claim 11 further comprising:
confirming that an ignition is off prior to driving the piston.

15. The method set forth in claim 11, wherein the parameter is a time duration.

16. The method set forth in claim 11, wherein the parameter is distance of travel.

17. The method set forth in claim 16, wherein the distance of travel is distance of piston travel.

18. The method set forth in claim 11, wherein the piston bears upon a brake pad that bears upon a brake disc when in the clamped position.

19. The method set forth in claim 11 further comprising:
preprogramming a controller with the retracted position.

20. The method set forth in claim 19 further comprising:
engaging a stop carried between the piston and a caliper;
sensing a second current spike by the controller and associated with the retracted position.
